(19) United States
(12) Patent Application Publication
(10) Pub. No.: US 2026/0161275 A1
(43) Pub. Date: Jun. 11, 2026

(54) DISPLAY CONTROL METHOD, ELECTRONIC DEVICE, AND STORAGE MEDIUM

(71) Applicant: Lenovo (Beijing) Limited, Beijing (CN)

(72) Inventor: Xin ZHOU, Beijing (CN)

(21) Appl. No.: 19/178,556

(22) Filed: Apr. 14, 2025

(30) Foreign Application Priority Data
Apr. 17, 2024 (CN) 202410465711.X

(51) Int. Cl. G06F 3/04845; G06F 3/0481

(52) U.S. Cl. CPC G06F 3/04845; G06F 3/0481; G06F 2203/04803

(57) ABSTRACT

A display control method, an electronic device, and a storage medium are provided in the present disclosure. The display control method includes, in response to obtaining a first target input operation, controlling a conversation window of a first application executing current interactive task to switch from a first display state to a second display state. The conversation window only includes a main window in the first display state and includes the main window and at least one extended window in the second display state; the at least one extended window is connected to a window edge of the main window; and a functional service provided by an extended window is different from a functional service provided by the main window.

### CROSS-REFERENCE TO RELATED APPLICATION

This application claims the priority of Chinese Patent Application No. 202410465711.X, filed on Apr. 17, 2024, the content of which is incorporated herein by reference in its entirety.

### TECHNICAL FIELD

The present disclosure generally relates to the field of computer technology, and, more particularly, relates to, a display control method, an electronic device, and a storage medium.

### BACKGROUND

When a user opens a new page from current page during a page browsing process (e.g., when the user opens the new page by clicking a link or button in current page), the new page may be opened in a new browser window or application window instead of in current page window or tab. In addition, the new page window may have a low correlation with original page window, which may give the user a strong sense of disconnection. Meanwhile, the window corresponding to the new page may pop up suddenly, which may give the user a bad experience of being abrupt or interrupting current operation.

Therefore, there is a need to provide a display control method for how to display newly opened page window of the user, which may provide the user with a smooth page opening experience.

### SUMMARY

One aspect of the present disclosure provides a display control method. The method includes, in response to obtaining a first target input operation, controlling a conversation window of a first application executing current interactive task to switch from a first display state to a second display state. The conversation window only includes a main window in the first display state and includes the main window and at least one extended window in the second display state; at least one of at least one of the at least one extended window is connected to a window edge of the main window; and a functional service provided by an extended window is different from a functional service provided by the main window.

Another aspect of the present disclosure provides an electronic device. The electronic device includes a memory, configured to store a computer program; and one or more processors, configured to, when the computer program is executed, perform a display control method. The method includes, in response to obtaining a first target input operation, controlling a conversation window of a first application executing current interactive task to switch from a first display state to a second display state. The conversation window only includes a main window in the first display state and includes the main window and at least one extended window in the second display state; at least one of the at least one extended window is connected to a window edge of the main window; and a functional service provided by an extended window is different from a functional service provided by the main window.

Another aspect of the present disclosure provides a non-transitory computer-readable storage medium, containing a computer program for when executed by one or more processors, performing a display control method. The method includes, in response to obtaining a first target input operation, controlling a conversation window of a first application executing current interactive task to switch from a first display state to a second display state. The conversation window only includes a main window in the first display state and includes the main window and at least one extended window in the second display state; at least one of the at least one extended window is connected to a window edge of the main window; and a functional service provided by an extended window is different from a functional service provided by the main window.

Other aspects of the present disclosure may be understood by those skilled in the art in light of the description, the claims, and the drawings of the present disclosure.

### BRIEF DESCRIPTION OF THE DRAWINGS

The accompanying drawings herein are incorporated into the present disclosure and constitute a part of the present disclosure. The accompanying drawings illustrate embodiments consistent with the present disclosure and are used together with the specification to illustrate the technical solutions of the present disclosure.

FIG. 1 illustrates an implementation flowchart of a display control method according to various embodiments of the present disclosure.

FIG. 2 illustrates an exemplary display interface schematic of a display control method according to various embodiments of the present disclosure.

FIG. 3 illustrates another exemplary display interface schematic of a display control method according to various embodiments of the present disclosure.

FIG. 4 illustrates another exemplary display interface schematic of a display control method according to various embodiments of the present disclosure.

FIG. 5 illustrates another implementation flowchart of a display control method according to various embodiments of the present disclosure.

FIGS. 6-12 illustrate exemplary display interface schematics of a display control method according to various embodiments of the present disclosure.

FIG. 13 illustrates a composition structural schematic of a display control apparatus according to various embodiments of the present disclosure.

FIG. 14 illustrates a hardware entity schematic of a computer device according to various embodiments of the present disclosure.

### DETAILED DESCRIPTION

To clearly describe the objectives, the technical solutions and advantages of the present disclosure, the technical solutions of the present disclosure are further described in detail below in combination with accompanying drawings and embodiments. The described embodiments should not be regarded as limiting the present disclosure. All other embodiments obtained by those skilled in the field without creative work are within the protection scope of the present disclosure.

In the following description, “some embodiments” involved may describe a subset of all possible embodiments, but it should be understood that “some embodiments” may be same subset or different subsets of all possible embodiments and may be combined with each other without conflict.

The terms “first/second/third” involved may be only used to distinguish similar objects and may not represent a specific order for objects. It should be understood that “first/second/third” may be interchanged with a specific order or sequence where permitted, such that embodiments of the present disclosure described herein may be implemented in an order other than that illustrated or described herein.

Unless otherwise defined, all technical and scientific terms used herein may have same meaning as those understood by those skilled in the field of the present disclosure. The terms used herein may be only for the purpose of describing the present disclosure and may be not intended to limit the present disclosure.

Embodiments of the present disclosure provide a display control method, which may be executed by a processor of a computer device. The computer device may refer to a device with display control capability, including a server, a laptop, a tablet computer, a desktop computer, a smart TV, a set-top box, a mobile device (e.g., a mobile phone, a portable video player, a personal digital assistant, a dedicated messaging device or a portable gaming device) and/or the like.

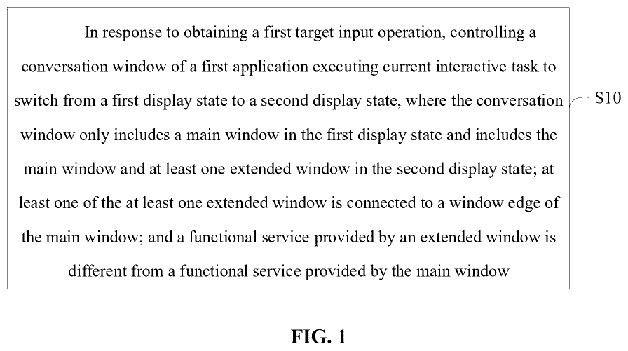

FIG. 1 illustrates an implementation flowchart of a display control method according to various embodiments of the present disclosure. Referring to FIG. 1, the method may include following exemplary step S10.

At S10, in response to obtaining the first target input operation, the conversation (e.g., chat) window of the first application executing current interactive task may be switched from the first display state to the second display state. The conversation window may only include the main window in the first display state and include the main window and at least one extended window in the second display state. At least one of extended windows may be connected to a window edge of the main window, and the functional service provided by the extended window may be different from the functional service provided by the main window.

In one embodiment, the first application may refer to an application that may provide a conversation or search function for the user.

The first application may include the conversation window; and the conversation window may be configured to provide intelligent search, intelligent interaction or specific functional services to the user.

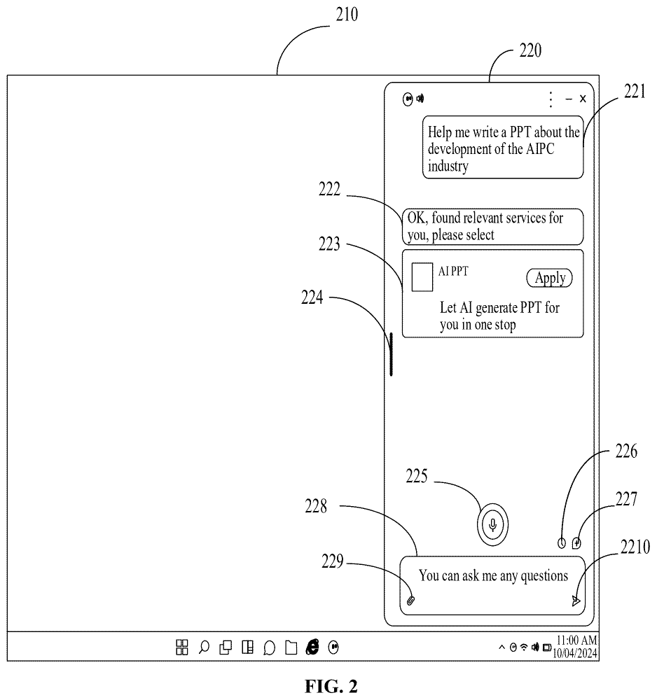

When the conversation window is in the first display state, the conversation window may include the main window. In some embodiments, the main window may provide users with a variety of functional services, such as intelligent question-and-answer services, intelligent search services, translation services, document continuation services, text polishing services, display parameter adjustment services for the conversation window, device control services for devices communicating with the first application, and the like. In such way, the user may obtain multiple functional services through the main window. As shown in FIG. 2, in the display screen 210 that the first application is running, a main window 220 may be displayed; and multiple identifier options may be displayed in the main window 220 to provide users with multiple functional services. For example, the user may obtain services such as intelligent search and question-and-answer and the like by entering text in the text input box 228; input voice information through the voice input control 225; click the service recommendation tab (label) in the conversation item 223 to obtain corresponding functional service; and the like.

When the conversation window is in the second display state, the conversation window may include the main window and at least one extended window.

In one embodiment, the extended window may be a window extended from the main window based on the user's operation behavior. In some embodiments, each extended window may be configured to provide a certain functional service. For example, when the extended window corresponds to an artificial intelligence (AI) PPT application, only the functional service corresponding to the AI PPT application may be displayed in the extended window.

In such way, the second display state may be considered to be at least one extended window in an expanded state relative to the main window, and the first display state may be considered to be at least one extended window in a stored state relative to the main window.

At least one of extended windows may be connected to the window edge of the main window. For example, when at least one extended window is tiled on one side of the main window, only one extended window adjacent to the main window may be connected to the window edge of the main window; when at least one extended window is tiled around multiple sides of the main window, multiple extended windows adjacent to the main window may be connected to a corresponding window edge of the main window; when at least one extended window is stacked on one side of the main window, each extended window may be connected to a corresponding window edge of the main window.

The first target input operation may refer to an operation that triggers the first application to generate at least one extended window.

In some embodiments, the first target input operation may include an operation of calling at least one function service displayed in the main window. For example, the user may click on the service recommendation tab (label) of the AI PPT function displayed in the main window to generate an extended window corresponding to the AI PPT function service; that is, the conversation window may be switched from the first display state to the second display state.

In some embodiments, the first target input operation may include an operation of the user inputting voice information through the audio acquisition apparatus of the electronic device. For example, the user may input an operation instruction to open the AI PPT function service in the main window through voice input operation, thereby generating the extended window corresponding to the AI PPT function service; that is, the conversation window may be switched from the first display state to the second display state.

In some embodiments, the first target input operation may include an operation of the user inputting question information in the main window. For example, the user may input question information in the main window by a manner including voice, string input and/or the like; in response to the question information, the intelligent assistant may determine corresponding response information; when the amount of data corresponding to the response information is relatively large, corresponding extended window may be generated to display the response information in the extended window.

In some embodiments, the first target input operation may include an operation of the user triggering a certain function control in the main window. For example, the main window may include a function control for expanding the extended window; and in response to the user's triggering operation on the function control, corresponding extended window may be extended.

In some embodiments, the first target input operation may also include the user triggering operation on a third-party knowledge base, application, or address link displayed in the main window. For example, an address link of a third-party website may be displayed in the main window; and in response to the user triggering operation on the address link, corresponding extended window may be expanded to display the third-party website page in the extended window.

In the display control method provided by the present disclosure, in response to the first target input operation, the conversation window of the first application may be controlled to switch from the first display state to the second display state. The conversation window may only include the main window in the first display state and may include the main window and at least one extended window in the second display state; at least one of the extended windows may be connected to the window edge of the main window; and the functional services provided by the extended window may be different from the functional services provided by the main window. In such way, when the user operates currently displayed main window and needs to open a certain functional service, at least one extended window connected to the main window may be generated for the conversation window. Through the edge connection relationship of the windows, the user may feel the association between the extended window and the main window; and in the second display state, the main window and at least one extended window may be displayed simultaneously, the context information of current window may be maintained, and the user may use the services provided by the main window and the extended window simultaneously.

In some embodiments, the conversation window of the first application executing current interactive task may be controlled to switch from the first display state to the second display state; that is, above-mentioned exemplary step S10 may be implemented by following exemplary steps.

At one operational step, the conversation window may be controlled to switch from only displaying the main window to displaying the main window and at least one extended window simultaneously, and control at least one option identifier in the main window to switch from a first state to a second state.

In one embodiment, the option identifier may refer to the identifier information corresponding to multiple functional services displayed in the main window.

In some embodiments, the option identifier may include at least one of the following: an option identifier corresponding to the local knowledge base, an option identifier for displaying or hiding the extended window, an option identifier for triggering the third-party functional service and/or the like.

In some embodiments, by triggering at least one option identifier in the main window, the conversation window may be controlled to switch from only displaying the main window to simultaneously displaying the main window and at least one corresponding extended window.

In some embodiments, after the conversation window is controlled to switch to display the main window and at least one extended window, the option identifier corresponding to at least one extended window in the main window may be controlled to switch from the first state to the second state.

The first state of the option identifier may represent that the option identifier is in an untriggered display state; and the second state of the option identifier may represent that the option identifier is in a triggered display state.

In some embodiments, in the first state and the second state, the option identifier may different transparency, display positions, shapes and the like, such that the user may determine whether the function service corresponding to the option identifier is triggered based on the state of the option identifier.

At one operational step, the conversation window may be controlled to switch from only displaying the main window to simultaneously displaying the main window and at least one extended window; and display and output the first target content in the extended window, where the first target content may be obtained from the main window or generated from the first target input operation.

In one embodiment, in response to the first target input operation, after the conversation window is switched from only displaying the main window to simultaneously displaying the main window and at least one extended window, a part of the content of the main window or the content generated by the first target input operation may be displayed in the extended window.

In some embodiments, when the first target content is obtained from the main window, certain functional services in the main window may be moved to the extended window for display.

In some embodiments, after the conversation window is switched to the second display state, the identifier options displayed in the main window for controlling the display and storage of the extended window may be moved to the extended window for display. For example, in the first display state, a triangle symbol may be configured at the edge of the main window to control the expansion of the extended window relative to the main window; and in the second display state, the triangle symbol may be moved to the edge of the extended window for display to control the extended window to be stored into the main window.

In some embodiments, after the conversation window switches to the second display state, the identifier options displayed in the main window for controlling the display parameters of the conversation window may be moved to the extended window for display; or, after the conversation window switches to the second display state, the identifier options only for controlling the display parameters of the main window may be displayed in the main window, and the identifier options only for controlling the display parameters of the extended window may be displayed in the extended window.

In some embodiments, when the first target content is generated from the first target input operation, the first target content may be the result information determined based on the first target input operation. For example, when the first target input operation is inputting the question information by the user in the main window, the first target content may be response information for the question information.

Above-mentioned exemplary step of displaying and outputting the first target content in the extended window may be implemented by following exemplary steps.

At one operational step, the attribute information of the target object pointed by the first target input operation may be determined; and based on the attribute information, the extended window may be controlled to display and output the target object from the main window or display and output the associated content generated after the target object is triggered.

The target object pointed by the first target input operation may refer to the object information determined based on the first target input operation. For example, when the first target input operation is inputting the question information by the user, the target object may include the response information corresponding to the question information; and when the first target input operation is inputting the search information by the user, the target object may include the search result information corresponding to the search information.

The attribute information of the target object may refer to the type information of the target object. In some embodiments, the type information of the target object may include operable type objects and inoperable type objects. The operable type objects may refer to objects that may be further operated to obtain corresponding functional services, such as control icons, hyperlinks, hyperlink icons, shortcut icons and the like corresponding to certain functional services. Inoperable type objects may refer to objects that cannot be further operated to obtain functional services, such as files, pictures, texts, voices, videos and the like.

In some embodiments, when the attribute information characterizes that the target object is the operable-type object, the extended window may be controlled, based on the attribute information, to display the associated content generated after the target object is triggered.

For example, when the target object is a hyperlink icon, the web page or original file (e.g., reference or data source) corresponding to the hyperlink icon may be displayed and output in the extended window; when the target object is a window setting identifier, the window setting interface corresponding to the setting identifier may be displayed in the extended window; and when the target object is an identifier corresponding to a design function service, corresponding design interface (e.g., a PPT design interface) may be displayed in the extended window and the like.

In some embodiments, when the attribute information characterizes that the target object is the inoperable-type object, the extended window may be controlled to display and output the target object from the main window based on the attribute information.

For example, when the target object is a picture, the picture may be displayed and output in the extended window; and when the target object is a file, detailed content of the file may be displayed in the extended window. In some embodiments, the target object may be switched to be displayed in the extended window by a manner including single-clicking, double-clicking, dragging and/or the like.

At one operational step, the operation region of the first target input operation may be determined; and based on the operation region, the extended window may be controlled to display and output the target object from the operation region or display and output the associated content matching the first target input operation.

In one embodiment, the operation region may be a different functional region in the main window.

In some embodiments, the operation region may include a response interaction region, a response data output region, and a function option region.

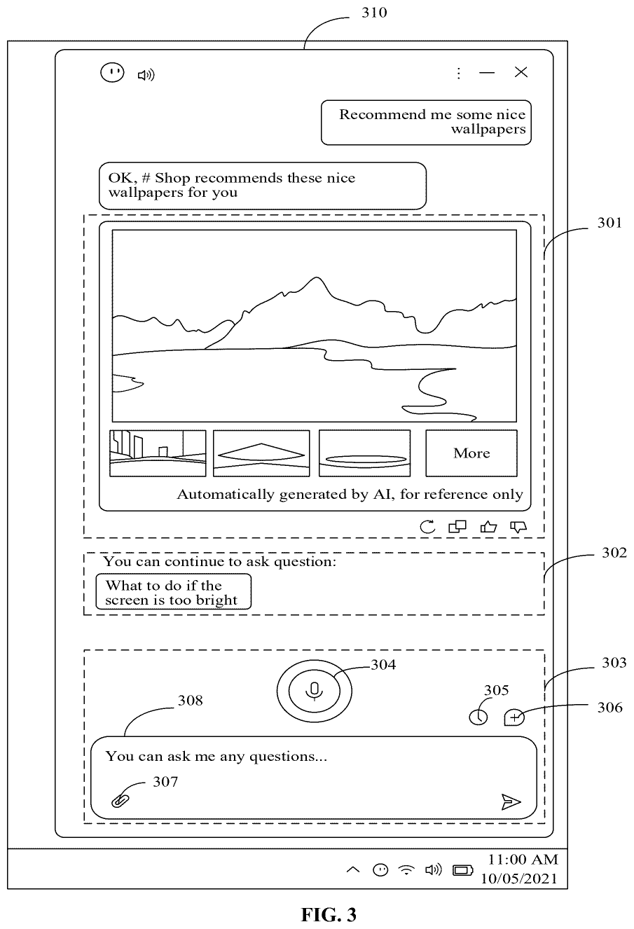

As shown in FIG. 3, the main window 310 may include a response interaction region 301, a response data output region 302, and a function option region 303. According to the question raised by the user “help me recommend some good-looking wallpapers”, the intelligent assistant may display multiple wallpaper pictures in the response interaction region 301 and recommend the question “what should I do if the screen is too bright” in the response data output region 302, such that the user may continue to ask questions. Meanwhile, in the function option region 303, multiple function identifier options may be configured, including the voice input control 304 configured to provide voice input function, the history information control 305 configured to trigger the display of historical interaction information, new conversation control 306 configured to create a new topic in the main window, the insert file control 307 configured to upload files in the main window, and the text input box 308 configured to receive string information inputted by the user through a device such as a keyboard or the like.

In some embodiments, when the operation region of the first target input operation is the response interaction region, the target object displayed in the response interaction region (e.g., the wallpaper image in the response interaction region 301) may be displayed and outputted to the extended window.

In some embodiments, when the operation region of the first target input operation is the response data output region, the associated content of the content displayed in the response data output region may be displayed in the extended window (e.g., the response result information for the question raised in the response data output region 302) based on the first target input operation being a click operation, a slide operation or other operations.

In some embodiments, when the operation region of the first target input operation is the function option region, the associated content of the function option corresponding to the first target input operation may be displayed in the expanded window (e.g., the file content inserted using the insert file control 307 in the function option region 303).

At one operational step, the behavior parameter of the first target input operation may be determined; and based on the behavior parameter, the extended window may be controlled to display and output current display content or folded display content from the main window or display and output the associated content matching the first target input operation.

In one embodiment, the behavior parameter may refer to the type parameter of the first target input operation. In some embodiments, the behavior parameter may include a question type operation and a function service call type operation.

In some embodiments, when the behavior parameter of the first target input operation characterizes that the first target input operation is a question type operation, current display content or folded display content (that is, the response result information corresponding to the first target input operation) from the main window may be displayed in the extended window. For example, when the data volume of the response result information corresponding to the first target input operation is relatively small (e.g.,, a small amount of image content or text content) and the response result information is fully displayed in the main window, current display content in the main window may be switched to the extended window; and when the data volume of the response information corresponding to the first target input operation is relatively large and the response result information is folded in the main window (e.g., only thumbnails of some images are displayed due to a large quantity of images; or only summary or a part of the text content is displayed due to a large quantity of text content), the folded content in the main window may be expanded and displayed in the extended window, that is, fully displayed.

In some embodiments, when the behavior parameter of the first target input operation characterizes that the first target input operation is an operation of the function service call type, the associated content matching the first target input operation may be displayed in the extended window. For example, when the first target input operation is a call operation for a certain function service, the service page corresponding to the function service may be displayed in the extended window.

At one operational step, the conversation window may be controlled to switch from only displaying the main window to simultaneously displaying the main window and at least one extended window; and at least the main window may be controlled to switch from the first display parameter to the second display parameter.

In one embodiment, after controlling the conversation window to switch from only displaying the main window to simultaneously displaying the main window and at least one extended window in response to the first target input operation, the display parameter of the main window may be adjusted, such that the user may quickly distinguish the main window from the extended window through different display effects.

In some embodiments, the display parameters may include transparency, a theme type, a font size, a font, a color, a thickness of the window border and the like which may correspond to the main window.

In one embodiment, the first display parameter and the second display parameter may be different display parameters.

In some embodiments, at least one extended window may also be controlled to be displayed with display parameters different from the main window.

In some embodiments, the conversation window of the first application may be controlled to switch from the first display state to the second display state; that is, above-mentioned exemplary step S10 may be implemented by following exemplary steps.

At one operational step, the conversation window may be controlled to switch from only displaying the main window to simultaneously displaying the main window and the first extended window; and the right edge of the first extended window may be connected to the left edge of the main window.

In one embodiment, the first extended window may be displayed on the left side of the main window, and the right edge of the first extended window may be connected to the left edge of the main window.

In some embodiments, when the conversation window is controlled to switch from the first display state to the second display state, the first extended window may be controlled to gradually slide out from the left edge of the main window, such that the user may feel the association between the extended window and the main window.

At one operational step, the conversation window may be controlled to switch from only displaying the main window to simultaneously displaying the main window and the second extended window, and the lower edge of the second extended window may be connected to the upper edge of the main window.

In one embodiment, the second extended window may be displayed on the upper side of the main window, and the lower edge of the second extended window may be connected to the upper edge of the main window.

In some embodiments, when the control conversation window is switched from the first display state to the second display state, the second extended window may be controlled to gradually slide out from the upper edge of the main window, such that the user may feel the association between the extended window and the main window.

At one operational step, the conversation window may be controlled to switch from only displaying the main window to simultaneously displaying the main window and the third extended window, and the upper edge of the third extended window may be connected to the lower edge of the main window.

In one embodiment, the third extended window may be displayed on the lower side of the main window, and the upper edge of the third extended window may be connected to the lower edge of the main window.

In some embodiments, when the conversation window is controlled to switch from the first display state to the second display state, the third extended window may be controlled to gradually slide out from the bottom edge of the main window, such that the user may feel the association between the extended window and the main window.

At one operational step, the conversation window may be controlled to switch from only displaying the main window to simultaneously displaying the main window and the fourth extended window, and the left edge of the fourth extended window may be connected to the right edge of the main window.

In one embodiment, the fourth extended window may be displayed on the right side of the main window, and the right edge of the fourth extended window may be connected to the right edge of the main window.

In some embodiments, when the conversation window is controlled to switch from the first display state to the second display state, the fourth extended window may be controlled to gradually slide out from the right edge of the main window, such that the user may feel the association between the extended window and the main window.

At one operational step, the conversation window may be controlled to switch from only displaying the main window to simultaneously displaying the main window and multiple fifth extended windows; multiple fifth extended windows may be stacked on the left side of the main window and all connected to the left edge of the main window; or multiple fifth extended windows may be tiled on the left side of the main window.

In one embodiment, multiple fifth extended windows may be displayed on the left side of the main window.

In some embodiments, multiple fifth windows may also be displayed on the right, upper or lower side of the main window.

When multiple fifth extended windows are stacked on the left side of the main window, the right edge of each fifth extended window may be connected to the left edge of the main window.

In some embodiments, the fifth extended window currently operated by the user may be displayed on the top layer of the multiple fifth extended windows stacked with each other.

In some embodiments, a tab bar may be configured at the top of multiple fifth extended windows to generate corresponding tab information for each fifth extended window in the tab bar, such that the user may switch multiple fifth extended windows.

When multiple fifth extended windows are tiled on the left side of the main window, the fifth extended windows may be expanded from the main window to the left in sequence according to the order in which the user opens each fifth extended window.

In some embodiments, it determines whether the fifth extended windows are configured in a tiling or stacking manner according to the user's usage habits.

In some embodiments, it determines whether the fifth extended windows are configured in a tiling or stacking manner according to the size of the display screen of the electronic device. For example, when the display screen of the electronic device is relatively large, the fifth extended windows may be configured in a tiling manner; correspondingly, when the display screen of the electronic device is relatively small, the fifth extended windows may be configured in a stacking manner.

In some embodiments, it determines whether the fifth extended windows are configured in a tiled or stacked manner according to the functional service type corresponding to each fifth extended window. For example, the fifth extended windows of same functional service type may be configured in a tiled manner, such that the user may compare the running effects of multiple functional services of same type; and the fifth extended windows of different functional service types may be configured in a stacked manner, such that the user may switch the display between different functional service windows. However, the fifth extended windows of same functional service type may be also configured in a stacked manner, and the fifth extended windows of different functional service types may be also configured in a tiled manner, which may be not limited herein.

In some embodiments, whether the fifth extended windows are configured in a tiled or cascaded manner may be determined according to the running state of the functional service corresponding to each fifth extended window. For example, the fifth extended windows whose functional service is in the file download or application installation state may be configured in a cascaded manner; and the fifth extended window whose functional service is in operation may be configured in a tiled manner.

At one operational step, the conversation window may be controlled to switch from only displaying the main window to simultaneously displaying the main window, at least one sixth extended window and at least one seventh extended window. The sixth extended window may be configured on the left side of the main window and connected to the left edge of the main window; and the seventh extended window may be configured on the right side of the main window and connected to the right edge of the main window.

In one embodiment, when there are multiple extended windows, multiple extended windows may be configured on different sides of the main window.

The sixth extended window may be configured on the left side of the main window, such that the right edge of the sixth window may be connected to the left edge of the main window; and the seventh extended window may be configured on the right side of the main window, such that the left edge of the seventh window is connected to the right edge of the main window.

In some embodiments, the sixth extended window may also be configured on the upper side of the main window, such that the lower edge of the sixth window may be connected to the upper edge of the main window; and the seventh extended window may be configured on the lower side of the main window, such that the upper edge of the seventh window may be connected to the lower edge of the main window.

In some embodiments, the sixth extended window may also be configured on the left side of the main window, such that the right edge of the sixth window may be connected to the left edge of the main window; and the seventh extended window may be configured on the upper side of the main window, such that the lower edge of the seventh window may be connected to the upper edge of the main window.

In some embodiments, the conversation window of the first application may be controlled to switch from the first display state to the second display state; that is, above-mentioned step S10 may be implemented by following exemplary steps.

At one operational step, the quantity and/or type of operation objects acted by the first target input operation may be obtained; and based on the quantity and/or type of the operation objects, the conversation window may be controlled to switch from only displaying the main window to simultaneously displaying the main window and the target quantity of extended windows, where the quantity of extended windows may be same as or different from the quantity of the operation objects.

In one embodiment, the operation object may refer to the identifier option, certain data and the like in the main window corresponding to the first target input operation.

The types of operation objects may include objects that can trigger corresponding functional service process and objects that cannot trigger corresponding functional service process.

In some embodiments, when the type of each operation object characterizes that corresponding operation object is an object that can trigger corresponding functional service process, an associated extended window may be generated for each operation object, that is, the quantity of operation objects may be same as the target quantity of extended windows.

In some embodiments, when the types of only a part of the operation objects characterize that corresponding operation objects are objects that can trigger corresponding functional service processes, only the associated extended windows may be generated for the part of the operation objects, that is, the quantity of operation objects may be different from the target quantity of extended windows.

In some embodiments, when the main window and the target quantity of extended windows are displayed simultaneously, the setting position of the extended window corresponding to each operation object may be determined based on the triggering order of each operation object by the first target input operation. For example, when multiple extended windows are displayed to be stacked with each other, the extended window corresponding to the later triggered operation object may be configured above the extended window corresponding to the earlier triggered operation object according to the triggering order of each operation object; and when multiple extended windows are displayed to be tiled in a right-to-left order, the extended window corresponding to the later triggered operation object may be configured to the left of the extended window corresponding to the earlier triggered operation object according to the triggering order of each operation object and the like.

In some embodiments, when the main window and the target quantity of extended windows are displayed simultaneously, the setting position of the extended window corresponding to each operation object may be determined based on the historical usage information of the user for the functional service process corresponding to each operation object. For example, firstly, the functional service process corresponding to each operation object may be prioritized according to the user's usage time information and usage frequency information of the functional service process corresponding to each operation object in a designated historical time period; next, when the main window and the target quantity of extended windows are displayed simultaneously, the extended window corresponding to the functional service process with higher priority may be configured at the upper layer of the extended windows displayed to be stacked with each other, or when the extended windows are tiled, the extended window corresponding to the functional service process with higher priority may be configured closer to the main window and the like. In such way, the functional service process with higher priority may be quickly located by the user.

At one operational step, the task process triggered by the first target input operation may be obtained, and the conversation window may be controlled to switch from only displaying the main window to simultaneously displaying the main window and the extended window matching the task process. The display layout information of the extended windows corresponding to different task processes may be different.

In one embodiment, the task process triggered by the first target input operation may refer to the task process created for corresponding functional service based on the first target input operation.

The extended window matching the task process may refer to, in the extended window configured to display the running page of the task process, a matching display layout generated for the task process based on the function type and function tab (label) of corresponding task process.

For example, for the task process corresponding to the AI PPT application, the layout design of corresponding extended window may need to include relevant content such as the PPT theme, outline, certain content page and the like; for the task process corresponding to the AI raw image application, the layout design of corresponding extended window may need to include relevant content such as the text input box, the picture display region and the like; for the AI application download application, the layout design of corresponding extended window may need to include content such as the application store and the like; for the AI customer service application, the layout design of corresponding extended window may need to include relevant content such as the customer service interaction window, the customer service assistant and the like.

In such way, by performing abstract process on the functions implemented by various task processes and generating extended windows containing corresponding display layout information, the user may quickly obtain desired functional services while simplifying the extended window interface.

In some embodiments, the display control method provided by the present disclosure may further include following exemplary step.

At one operational step, target reference information may be obtained, and the relative position between the extended window and the main window may be controlled based on the target reference information.

The target reference information may include at least one of the following: the usage habit of the target user; the screen configuration information of the electronic device; the application information of the second application currently running on the electronic device; the task process information carried by the extended window; and/or the quantity of extended windows.

In one embodiment, the target reference information may be configured to determine the configuration manner of the extended window relative to the main window.

The relative position between the extended windows and the main window may include where the extended window is configured relative to the main window, and how the multiple extended windows are configured when there are multiple extended windows. For example, the extended window may be configured on the upper side, lower side, left side or right side of the main window; and multiple extended windows may be tiled or stacked, and the like.

In one embodiment, the target reference information may include the usage habit of the target user. For example, when the target user is accustomed to right-handed operation, the extended window may be configured on the left side of the main window, such that the target user may refer to the information in the main window at any time, or use the main window to make further questions or searches; on the contrary, when the target user is accustomed to left-handed operation, the extended window may be configured on the right side of the main window.

The target reference information may include the screen configuration information of the electronic device. For example, when the screen configuration of the electronic device is relatively high, multiple extended windows may be tiled; when the screen configuration of the electronic device is relatively low, multiple extended windows may be stacked with each other.

The target reference information may include application information of the second application currently running on the electronic device.

In one embodiment, the second application may be an application displayed using the extended window.

In response to that the application information of the second application includes the application window size corresponding to the second application, when the application window size of the second application is relatively large, the extended window corresponding to the second application may be displayed in a stacked manner with other extended windows; on the contrary, when the application window size of the second application is relatively small, the extended window corresponding to the second application may be displayed in a tiled manner relative to other extended windows.

For example, in response to that the application information of the second application includes the application type corresponding to the second application, when the application type of the second application is a video application, the video application may be a type that is played and watched in real time for the user, such that the extended window corresponding to the second application may be displayed in a tiled manner relative to other extended windows; and when the application type of the second application is a text editing, web page, shopping type or the like, above-mentioned types of applications may be not types that need to be browsed in real time for the user, such that the extended window corresponding to the second application may be displayed in a stacked manner relative to other extended windows.

The target reference information may include the task process information carried by the extended window.

In some embodiments, the task process information may include the type information or name information of the task process and the like.

In some embodiments, the right side of the running page corresponding to the task process may be determined to be the user's regular operation side based on the type information of the task process, such that the extended window corresponding to the task process may be configured on the left side of the main window, and the right side of the extended window may be closer to the center of the display, which may be convenient for the user to operate. For example, the right side of the running page corresponding to the task process may be determined to be the main information display side of the task process based on the type information of the task process, the extended window corresponding to the task process may be configured on the left side of the main window, such that the right side of the extended window may be closer to the center of the display, which may be convenient for the user to browse the main information in the task process, and the like.

In some embodiments, the type information of the task may also be determined based on the name information of the task process, and then the setting position of the extended window corresponding to the task process may be determined.

The target reference information may include the quantity of extended windows. For example, when the quantity of extended windows is relatively small, the extended windows may be tiled on the display screen; and when the quantity of extended windows is relatively large, the extended windows may be stacked with each other on the display screen.

In some embodiments, the display control method provided by the present disclosure may further include following exemplary step.

At one operational step, in response to obtaining the second target input operation acting on the main window and/or the extended window, the second target content may be transferred between the main window and the extended window, thereby updating corresponding content in the extended window using the second target content or corresponding associated content, where the second target content may be generated based on the second target input operation.

In one embodiment, after controlling the conversation window to simultaneously display the main window and the extended window in response to the first target input operation, the second target input operation may be configured to update the content in the extended window.

In some embodiments, the second target input operation may include the input operation of the user in the main window.

In some embodiments, the second target input operation may include operations such as the user inputting search information, question information, image generation or video generation in the main window. For example, the user may input search information, question information, image generation information, video generation information or other information in the main window by a manner including voice, character string, gesture and/or the like.

In some embodiments, the second target operation may include a trigger operation of the user acting on at least one function option in the main window. For example, for the content displayed in the extended window, the user may optimize the content displayed in the extended window by triggering function options including polishing, translation, summary, continuation and/or the like in the main window.

In such way, when the second target input operation is an input operation of the user in the main window, the second target content may be generated based on the second target input operation; that is, the second target content may be the operation result corresponding to the second target input operation.

In some embodiments, the second target content generated based on the input operation in the main window may be transferred to a designated extended window, thereby updating corresponding content in the designated extended window. For example, when the second target content is a translation result for the text in a designated extended window, the translation result may be updated to corresponding position in the designated extended window.

In some embodiments, the second target content generated based on the input operation in the main window may also be transferred to multiple extended windows, thereby synchronously updating corresponding content in multiple extended windows. For example, when the second target content is a layout style setting for multiple extended windows, the layout style of each extended window may be updated based on the layout style setting result.

In some embodiments, the second target operation may include an input operation of the user in the extended window.

In some embodiments, the second target operation may include a user's selection operation on a part of the content displayed in the extended window, such as a word selection operation, a right-click operation and the like.

In some embodiments, when the second target input operation includes the input operation of the user in the extended window, the second target content may include original content (e.g., the word selection result in the extended window) and the pending operation (e.g., the right-click operation performed in the extended window) and the like in the extended window determined based on the second target input operation.

In some embodiments, firstly, the second target content may be determined in the extended window based on the second target input operation; next, based on the second target content, the second target content may be processed in the main window (e.g., search, translation, polishing and the like) to obtain the associated content of the second target content; and the associated content may be configured to update corresponding content in the extended window.

In some embodiments, transferring the second target content between the main window and the extended window may include transferring the second target content between the main window and one extended window, transferring the second target content between the main window and multiple extended windows, or transferring the second target content between different extended windows.

In some embodiments, transferring the second target content between the main window and the extended window may include transferring the second target content when the task process in each extended window starts or is executed; that is, the content displayed in the extended window may be updated at any stage of the task process.

In some embodiments, the second target content may be transferred between the main window and the extended window, thereby update corresponding content in the extended window using the second target content or corresponding associated content. In response to obtaining the second target input operation acting on the main window and/or the extended window, the second target content may be transferred between the main window and the extended window, thereby updating corresponding content in the extended window using the second target content or corresponding associated content, which may be implemented by following exemplary steps.

At one operational step, the second target content generated by the second target input operation acting on the main window may be transferred to the extended window, such that the first content in the extended window may be replaced with the second target content, and the update of the extended window may be completed, where the second target input operation may be an operation for optimizing the first content.

In one embodiment, the second target input operation may include an input operation acting on the main window. The second target content may be the content generated based on the second target input operation.

Optimization processing may refer to operations such as polishing, continuing, drawing, translating, extracting, summarizing, or switching display parameters (e.g., font, font size, color and the like) of the content in the extended window according to the user's intention.

Therefore, the second target input operation may be an operation that the user may update the content in the extended window according to user's own operation intention.

The first content may be the content selected by the user in the extended window, or the content in the extended window selected by the user through string input or voice input in the main window.

For example, after the user selects the first content in the extended window, the function option corresponding to the translation function in the main window may be triggered, and the translation information of the first content may be generated. The translation information of the first content may be the second target content.

In such way, the first content in the extended window may be replaced with the second target content, thereby completing the update of the extended window.

At one operational step, the second target content generated by the second target input operation acting on the extended window may be transferred to the main window, the associated content corresponding to the second target content may be generated in the main window, and the associated content may be transferred back to the extended window, thereby replacing the second target content in the extended window with the associated content and completing the update of the extended window.

In one embodiment, the second target input operation acting on the extended window may include operations such as word retrieval, right-click selection, screenshot and/or the like by the user on the extended window.

The second target content may be original content in the extended window determined based on the second target input operation. In one embodiment, the second target content may include text content, picture content, audio content, video content, and/or the like. The type of the second target content may be not limited herein.

After the second target content is determined in the extended window, the second target content may be synchronized to the main window.

In some embodiments, original content corresponding to the second target content may be transferred to the main window. For example, when the second target content is text content, entire text content may be transferred to the main window.

In some embodiments, the thumbnail content corresponding to the second target content may be transferred to the main window. For example, when the second target content is picture content, the thumbnail corresponding to the picture may be transferred to the main window.

In some embodiments, generating the associated content corresponding to the second target content in the main window may include optimizing the second target content, based on the user triggering the function option for optimizing the second target content in the main window, to obtain the associated content of the second content. For example, when the second target content is text content, in response to the user triggering the function option related to the translation function, the second target content may be translated to obtain the translation information corresponding to the second target content.

In some embodiments, generating associated content corresponding to the second target content in the main window may include optimizing the second target content, based on the user's voice or string input operation in the main window, to obtain associated content of the second content. For example, when the second target content is text content, in response to the user's search operation for finding related picture, the picture related to the second target content may be determined, and the picture search result may be used as the associated content of the second target content.

In such way, the second target content in the extended window may be replaced with the associated content of the second target content to update the extended window content.

At one operational step, the second target content generated by the second target input operation acting on the first extended window may be transferred to the main window, generating associated content corresponding to the second target content in the second extended window called up (or called) by the main window, and transferring the associated content back to the first extended window, thereby replacing the second target content in the extended window with the associated content and completing the update of the first extended window.

In one embodiment, the first extended window and the second extended window may respectively correspond to task processes that perform different functional services.

The second target content may be original content determined in the first extended window based on the second target input operation. In one embodiment, the second target content may include text information, pictures, audio information and/or video information and/or the like.

In some embodiments, transferring the second target content to the main window may include transferring complete content of the second target content to the main window, and may also include transferring the thumbnail content of the second target content to the main window.

In some embodiments, generating associated content corresponding to the second target content in the second extended window may include, based on received second target content, processing the second target content using the function service corresponding to the second extended window to obtain the associated content corresponding to the second target content.

In some embodiments, generating associated content corresponding to the second target content in the second extended window may include recommending corresponding functional services based on received second target content and the functional options triggered by the user or the operation instructions inputted by the user, and generating a corresponding second extended window for recommended functional services, thereby generating associated content corresponding to the second target content using the second extended window.

In some embodiments, transferring the associated content back to the first extended window may include the second extended window directly transferring the associated content back to the first extended window; or the second extended window transferring the associated content to the main window, and then the main window transferring the associated content back to the first extended window.

In such way, the second target content in the first extended window may be replaced with the associated content of the second target content to update the content of the first extended window.

In some embodiments, the display control method provided by the present disclosure may further include following exemplary step.

At one operational step, in response to the target event, the conversation window of the first application may be controlled to switch from simultaneously displaying the main window and at least one extended window to only displaying the main window.

In one embodiment, after obtaining a target event, the conversation window may be controlled to switch back from the second display state to the first display state, that is, the conversation window may be switched back to the state of displaying the main window.

In some embodiments, when the conversation window is switched back to the state where only the main window is displayed, the display parameters of the main window may also be adjusted. For example, the transparency, hue, theme style, font, font size and other information of the main window may be adjusted, thereby adjusting the display parameters of the main window to the first display state.

In such way, after the conversation window is switched back to the first display state, the display parameters of the main window may be adjusted, such that the user may quickly identify current state of the first application.

In one embodiment, the target event may include at least one of the following: target track operations acting on the extended window.

In some embodiments, the target track operations may include a user's gesture operation or mouse device operation on the extended window. For example, the user may slide a finger on the extended window along the direction of the main window; or the user may select the extended window with the mouse device and move the mouse along the direction of the main window.

In some embodiments, the target track operation may be a straight track or a curved track.

The target event may include the first operation acting on a target region of the first edge of the extended window, where the first edge may be a window edge away from an edge where the main window is connected to the extended window.

In one embodiment, the first edge of the extended window may be the window edge away from the edge where the main window is connected to the extended window. In some embodiments, the first edge of the extended window may also be the window edge of the extended window connected to the main window, or any other window edge of the extended window.

The target region may refer to a designated region in the first edge. In some embodiments, the target region may be in the middle of the first edge or near the top of the window.

In some embodiments, the target region may be identified using a designated identifier. For example, the target region may be indicated using a triangle symbol, an arrow symbol, a vertical line symbol or the like.

In some embodiments, the first operation may include operations such a single click, a double click, a long press or the like on the target region.

The target event may also include the second operation acting on a foldable control (e.g., foldable widget) of the extended window. The foldable control may be triggered by the second operation, such that the extended window may be stored in corresponding edge of the main window, and/or the foldable control may change corresponding control logic after the extended window is stored in corresponding edge of the main window.

In one embodiment, the foldable control may be configured to store or expand the extended window relative to the main window.

In some embodiments, when the extended window is stored in the main window, the foldable control may be displayed on a window edge of the main window; by triggering the foldable control, the extended window may be triggered to slide out from the edge of the main window for display; after the extended window slides out from the main window, the foldable control may be displayed on a window edge of the extended window away from the main window. At this point, by triggering the foldable control, the extended window may be triggered to be stored in the main window.

In one embodiment, the second operation may be a trigger operation for the foldable control, which may include operations such as a single click, a double click or a long press on the foldable control.

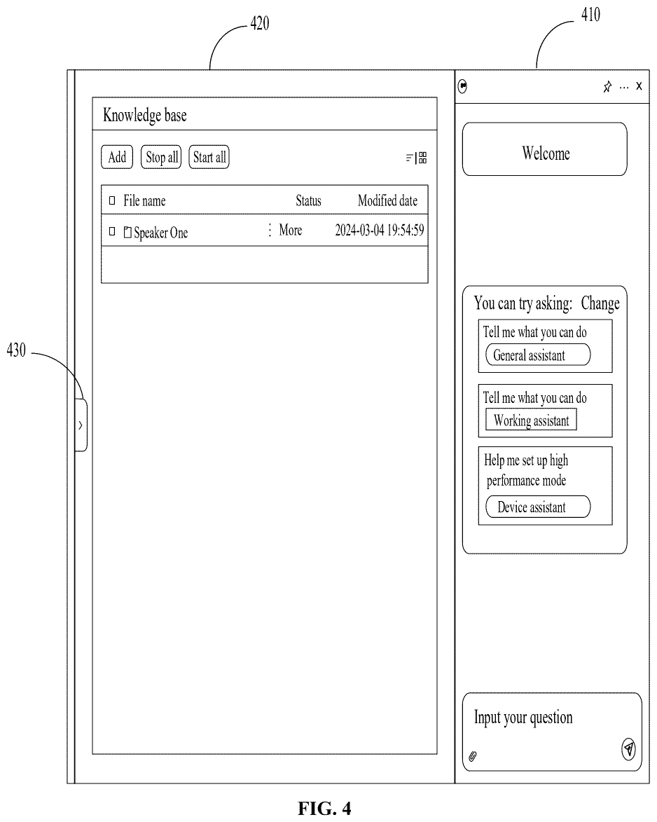

As shown in FIG. 4, the conversation window of the first application may include a main window 410 and an extended window 420 displayed on the left side of the main window 410; that is, the conversation window may be in the second display state. A foldable control 430 may be configured in the middle position of a window edge of the extended window 420 away from the main window 410.

In one embodiment, by clicking or long pressing the foldable control 430, the extended window 420 may be stored in the left edge of the main window 410; meanwhile, the foldable control 430 may be displayed on the left window edge of the main window 410.

The target event may also include detecting that the extended window displays the execution result of the target task.

In one embodiment, when the execution result of the target task in the extended window is displayed and outputted in the extended window, it indicates that the functional service in the extended window may have been completed. At this point, the conversation window may be switched to the first display state to save display screen space.

The target event may also include feedback information of the target prompt information for the target task displayed and outputted in the extended window, and the feedback information may be configured to accept or not accept the execution result of the target task.

In one embodiment, the target prompt information may be configured to prompt the user whether to save or export the execution result of the target task displayed in current extended window or prompt the user whether to continue to execute the target task displayed in current extended window.

The feedback information may characterize the user's acceptance or rejection of the target prompt information feedback.

In some embodiments, in response to the feedback information characterizing that the user accepts or does not receive the target task displayed by the extended window, the conversation window may be controlled to switch back to the first display state; that is, current extended window may be closed.

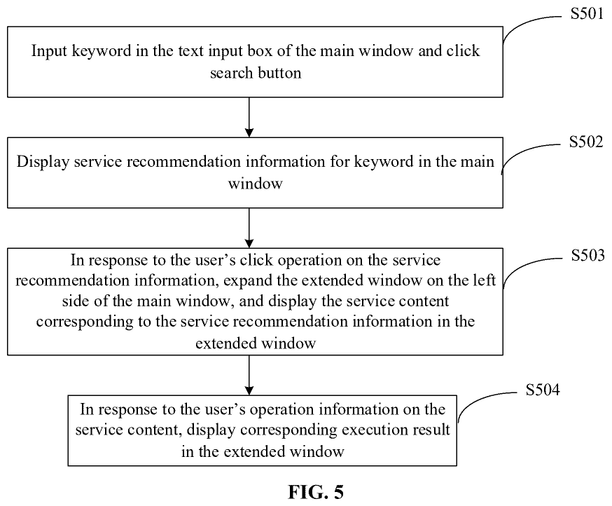

Referring to FIG. 5, the display control method provided by the present disclosure is described in one embodiment hereinafter. As shown in FIG. 5, following exemplary steps S501 to S504 may be included in one embodiment.

At S501, a keyword may be inputted in the text input box of the main window, and a search button may be clicked; subsequently, exemplary step S502 may be executed.

At S502, service recommendation information for the keyword may be displayed in the main window; subsequently, exemplary step S503 may be executed.

At S503, in response to the user's click operation on the service recommendation information, the extended window may be expanded on the left side of the main window, and the service content corresponding to the service recommendation information may be displayed in the extended window; subsequently, exemplary step S504 may be executed.

At S504, in response to the user's operation information on the service content, corresponding execution result may be displayed in the extended window.

Referring to FIGS. 2, 6 and 12, the display control method provided by the present disclosure is described in one embodiment hereinafter.

As shown in FIG. 2, the conversation window of the first application may be displayed in the display screen 210 of the electronic device, and the conversation window may be in the first display state; that is, only the main window 220 may be displayed.

A plurality of conversation items may be displayed in the main window 220. The conversation item 221 may be a conversation item containing question information issued by the user of the first application, for example, “Help me write a PPT about the development of the AIPC industry”; the conversation item 222 may be a conversation item fed back by the intelligent assistant corresponding to the first application; and the conversation item 223 may be the service recommendation information fed back by the intelligent assistant, that is, the service recommendation information corresponding to the AI PPT application.

The main window 220 may include a foldable control 224 in the shape of a vertical bar. By clicking the foldable control 224, the extended window may be expanded from the left edge of the main window 220.

The main window 220 may include a voice input control 225. By clicking the voice input control 225, the user may input voice information, thereby inputting control instructions through voice information.

The main window 220 may include a history information control 226. By clicking the history information control 226, the user may view the history interaction information.

The main window 220 may include a new conversation control 227. By clicking the new conversation control 227, the user may initiate a new conversation topic.

The main window 220 may include a text input box 228. The user may input string information in the text input box 228 through an input device such as a keyboard.

The main window 220 may include an insert file control 229. By clicking the insert file control 229, the user may upload the file to be processed in the main window.

The main window 220 may include a send control 2210. By clicking the send control 2210, the string information entered in the text input box 228 or the file uploaded by inserting the file control 229 may be sent to the intelligent assistant of the first application and displayed in the main window 220.

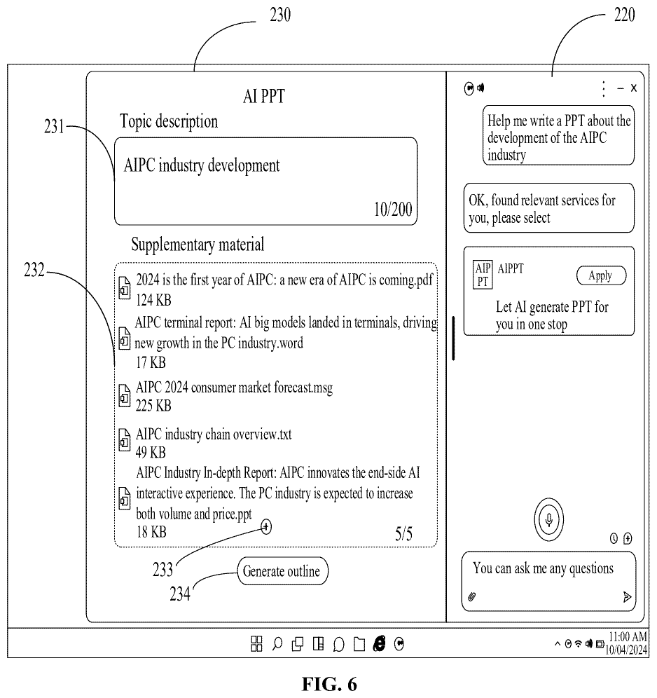

By clicking the service recommendation information in the conversation item 223 in FIG. 2, the extended window 230 may slide from the left side of the main window 220 for display, as shown in FIG. 6.

As shown in FIG. 6, the extended window 230 may include a text input box 231, a supplementary material display box 232, and an outline generation control 243.

The text input box 231 may include topic description information which may be obtained by extracting keywords from the question information entered by the user in the main window 220. The user may generate an outline based on the topic description information in the text input box 231 or continue to enter more detailed text description content in the text input box 231 to generate an outline that better meets the user's needs.

The supplementary material display box 232 may display multiple files uploaded by the user, such that AI PPT may generate an outline that better meets the user's needs based on the supplementary files. Meanwhile, the user may continue to add supplementary materials by clicking the “+” control 233 in the supplementary material display box 232.

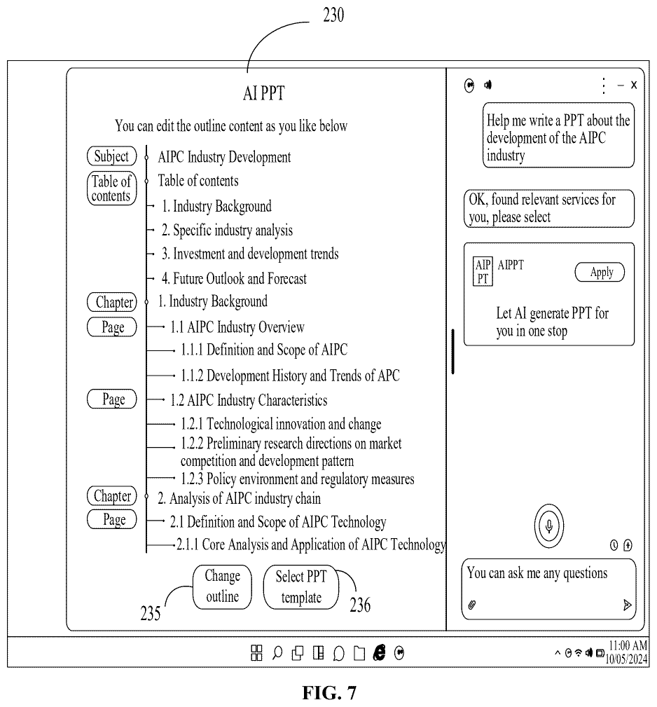

By clicking the outline generation control 234, a PPT outline may be generated based on the subject description information and the supplementary material information, as shown in FIG. 7.

As shown in FIG. 7, after the PPT outline is generated, the outline change control 235 and the select PPT template control 236 may be displayed in the extended window 230.

By clicking the outline change control 235, the user may update currently generated PPT outline.

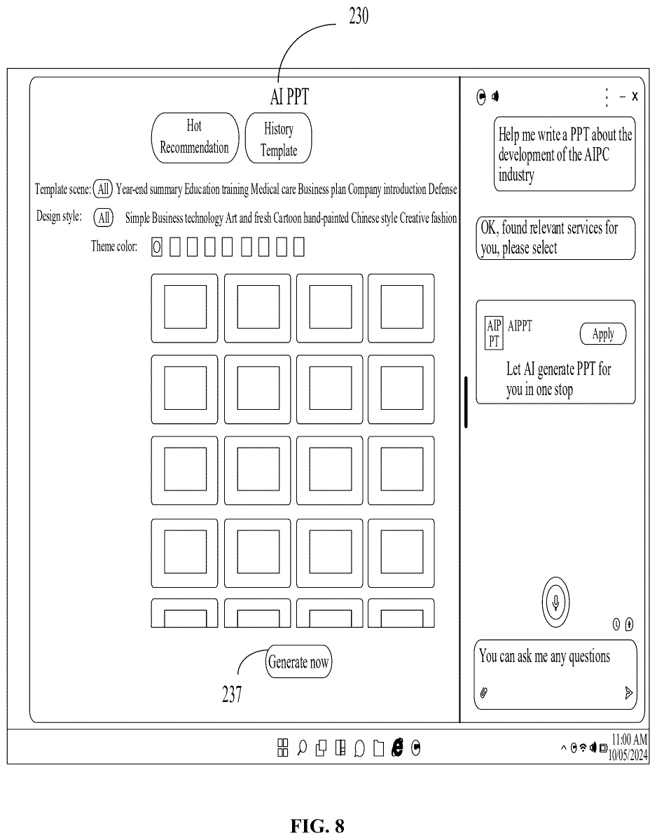

By clicking the PPT template selection control 236, the user may enter the PPT template selection page, as shown in FIG. 8.

As shown in FIG. 8, on the PPT template selection page, a plurality of PPT templates may be provided for the user to choose from.

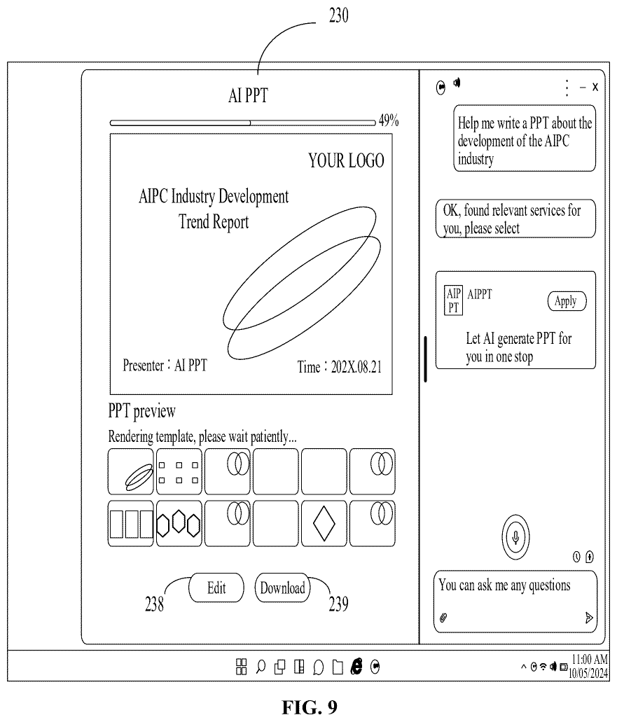

Meanwhile, on the PPT template selection page, a PPT generation control 237 may be provided. By clicking the PPT generation control 237, a corresponding PPT file may be generated based on generated PPT outline and the PPT template selected by the user, as shown in FIG. 9.

As shown in FIG. 9, a PPT preview interface may be displayed for the user in the extended window 230. Meanwhile, an edit control 238 and a download control 239 may be provided in the PPT preview interface.

By clicking the edit control 238, the user may edit the PPT content in the extended window 230.

By clicking the download control 239, the user may download the generated PPT.

Based on the outline shown in FIG. 7, the user may select a part of the content in the outline and optimize the selected content.

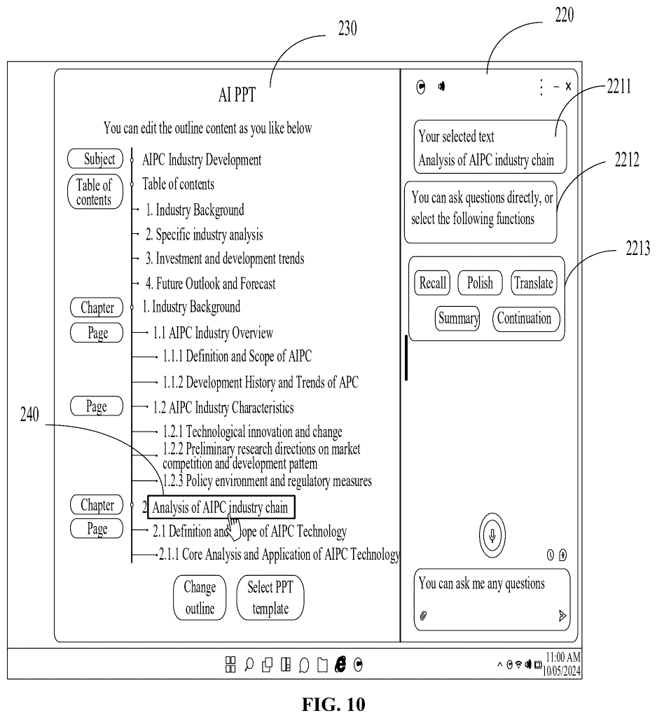

As shown in FIG. 10, the user may select the content “AIPC industry chain analysis” in the generated outline through the word selection operation and label the content with a word selection box 240.

In response to the user's word selection operation, the text content selected by the user may be displayed in the conversation item 2211 within the main window 220. Meanwhile, in the conversation item 2212, information guiding the user to continue asking questions may be displayed, that is, “You may ask questions directly, or select the following functions”; and in the conversation item 2213, a variety of optimization strategies may be provided for the user to choose, that is, “polishing”, “translation”, “summarization”, “continuation” and the like.

In addition, for the PPT preview page shown in FIG. 9, the user may continue to input editing information to modify the PPT content.

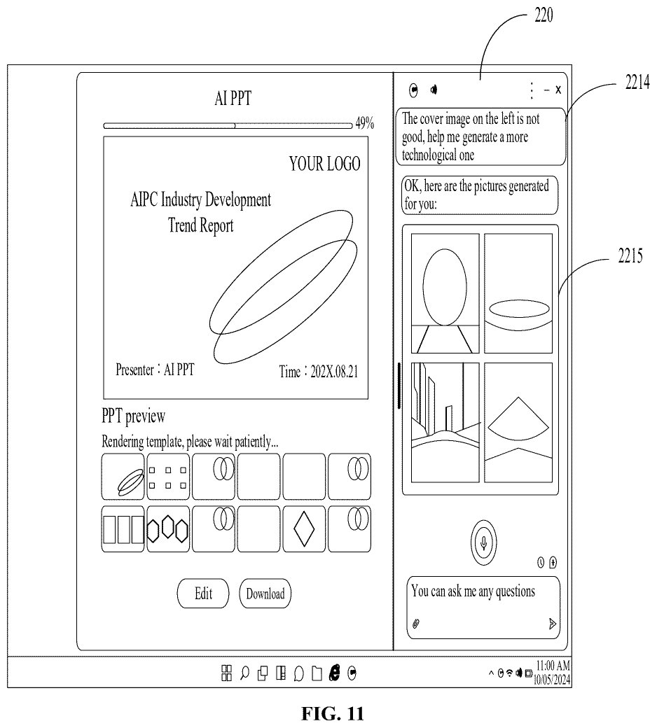

As shown in FIG. 11, the user may enter “The left cover is not good, help me generate a more technological one” in the conversation item 2214 within the main window 220. Accordingly, the intelligent assistant may search for images based on the user input information and display a part of the search results in the conversation item 2215.

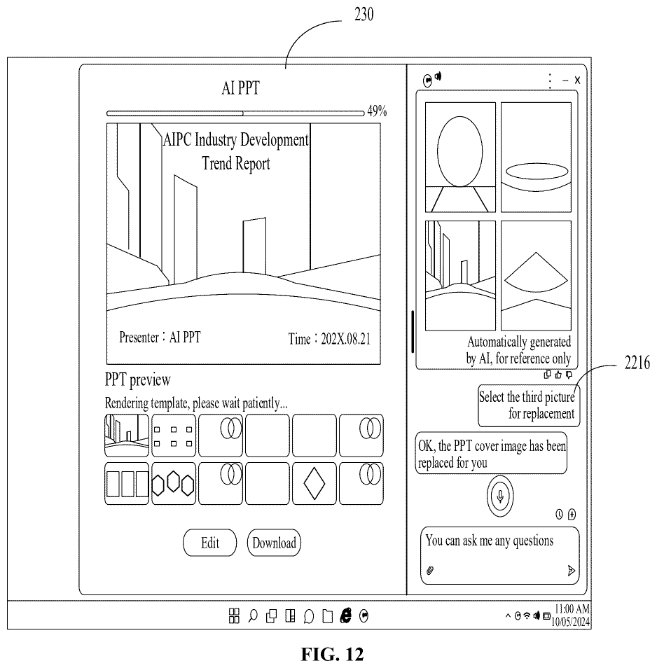

As shown in FIG. 12, the user may enter “select the third image for replacement” in the conversation item 2216; and in response to entered information, the cover page image of the PPT in the expansion window 230 may be replaced with the third image.

Based on above-mentioned embodiments, embodiments of the present disclosure provide a display control apparatus. The apparatus may include all units and the modules included in each unit, which may be implemented by a processor in a computer device and may also be implemented by a specific logic circuit. In an implementation process, the processor may be a central processing unit (CPU), a microprocessor (MPU), a digital signal processor (DSP) or a field programmable gate array (FPGA) or the like.

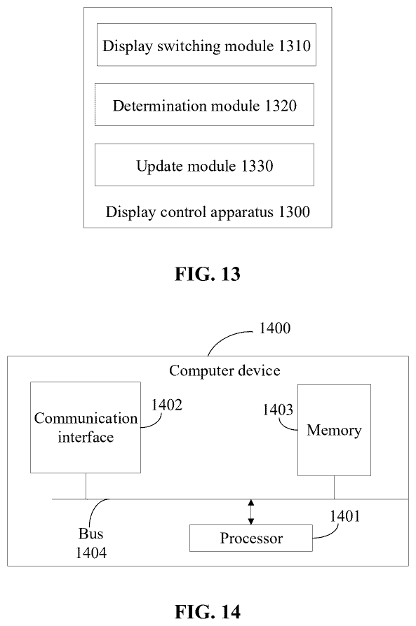

FIG. 13 illustrates a composition structural schematic of a display control apparatus according to various embodiments of the present disclosure. As shown in FIG. 13, a display control apparatus 1300 may include a display switching module 1310. The display switching module 1310 may be configured to, in response to obtaining the first target input operation, control the conversation window of the first application executing current interactive task to switch from the first display state to the second display state. The conversation window may include only the main window in the first display state and include the main window and at least one extended window in the second display state; and at least one of the extended windows may be connected to a window edge of the main window, and the functional service provided by the extended window may be different from the functional service provided by the main window.

In some embodiments, the display switching module 1310 may be configured to perform at least one of the following: controlling the conversation window to switch from only displaying the main window to simultaneously displaying the main window and at least one extended window, and controlling at least one option identifier in the main window to switch from the first state to the second state; controlling the conversation window to switch from only displaying the main window to simultaneously displaying the main window and at least one extended window, and displaying and outputting the first target content in the extended window, where the first target content may be obtained from the main window or generated from the first target input operation; or controlling the conversation window to switch from only displaying the main window to simultaneously displaying the main window and at least one extended window, and at least controlling the main window to switch from the first display parameter to the second display parameter.

In some embodiments, the display switching module 1310 may be configured to perform at least one of the following: determining the attribute information of the target object pointed by the first target input operation, and controlling the extended window to display and output the target object from the main window or display and output the associated content generated after the target object is triggered based on the attribute information; determining the operation region of the first target input operation, and controlling the extended window to display and output the target object from the operation region or display and output the associated content matching the first target input operation based on the operation region; or determining the behavior parameter of the first target input operation, and controlling the extended window to display and output current display content or folded display content from the main window or display and output the associated content matching the first target input operation based on the behavior parameter.

In some embodiments, the display switching module 1310 may be configured to perform at least one of the following: controlling the conversation window to switch from only displaying the main window to simultaneously displaying the main window and the first extended window, where the right edge of the first extended window may be connected to the left edge of the main window; controlling the conversation window to switch from only displaying the main window to simultaneously displaying the main window and the second extended window, where the lower edge of the second extended window may be connected to the upper edge of the main window; controlling the conversation window to switch from only displaying the main window to simultaneously displaying the main window and the third extended window, where the upper edge of the third extended window may be connected to the lower edge of the main window; controlling the conversation window to switch from only displaying the main window to simultaneously displaying the main window and the fourth extended window, where the left edge of the fourth extended window may be connected to the right edge of the main window; controlling the conversation window to switch from only displaying the main window to simultaneously displaying the main window and multiple fifth extended windows, where multiple fifth extended windows may be stacked on the left side of the main window and connected to the left edge of the main window, or the multiple fifth extended windows may be tiled on the left side of the main window; or controlling the conversation window to switch from only displaying the main window to simultaneously displaying the main window, at least one sixth extended window and at least one seventh extended window, where the sixth extended window may be configured on the left side of the main window and connected to the left edge of the main window, and the seventh extended window may be configured on the right side of the main window and connected to the right edge of the main window.

In some embodiments, the display switching module 1310 may be configured to perform at least one of the following: obtaining the quantity and/or types of operation objects acted by the first target input operation, and controlling the conversation window to switch from only displaying the main window to simultaneously displaying the main window and the target quantity of extended windows based on the quantity and/or types of the operation objects, where the quantity of extended windows may be same as or different from the quantity of the operation objects; or obtaining the task process triggered by the first target input operation, and controlling the conversation window to switch from only displaying the main window to simultaneously displaying the main window and the extended windows matching the task process, where the display layout information of the extended windows corresponding to different task processes may be different.

In some embodiments, the apparatus 1300 may further include a determination module 1320.

The determination module 1320 may be configured to obtain target reference information and control the relative position between the extended window and the main window based on the target reference information.

The target reference information may include at least one of the following: the target user's usage habits; the screen configuration information of the electronic device; the application information of the second application currently running on the electronic device; the task process information carried by the extended window; and/or the quantity of extended windows.

In some embodiments, the apparatus 1300 may further include an update module 1330.

The update module 1330 may be configured to transfer the second target content between the main window and the extended window in response to obtaining the second target input operation acting on the main window and/or the extended window, thereby updating corresponding content in the extended window using the second target content or corresponding associated content, where the second target content may be generated based on the second target input operation.

In some embodiments, the update module 1330 may be configured to perform at least one of the following. The second target content generated by the second target input operation acting on the main window may be transferred to the extended window, such that the first content in the extended window may be replaced with the second target content, and the update of the extended window may be completed, where the second target input operation may be an operation for optimizing the first content; the second target content generated by the second target input operation acting on the extended window may be transferred to the main window, the associated content corresponding to the second target content may be generated in the main window, and the associated content may be transferred back to the extended window, thereby replacing the second target content in the extended window with the associated content and completing the update of the extended window; and the second target content generated by the second target input operation acting on the first extended window may be transferred to the main window, generating associated content corresponding to the second target content in the second extended window called up by the main window, and transferring the associated content back to the first extended window, thereby replacing the second target content in the extended window with the associated content and completing the update of the first extended window.

In some embodiments, the display switching module 1310 may be also configured to control the conversation window of the first application to switch from simultaneously displaying the main window and at least one extended window to only displaying the main window in response to the target event.

The target event may include at least one of the following: the target track operation acting on the extended window; the first operation acting on the target region of the first edge of the extended window, where the first edge may be the window edge away from the edge where the main window is connected to the extended window; the second operation acting on the foldable control of the extended window, where the foldable control may be triggered by the second operation, such that the extended window may be stored in corresponding edge of the main window, and/or the foldable control may change corresponding control logic after the extended window is stored in corresponding edge of the main window; detecting the execution result of the target task displayed and outputted by the extended window; or obtaining feedback information for the target prompt information of the target task displayed and outputted by the extended window, where the feedback information may be configured to accept or not accept the execution result of the target task.

The description of above-mentioned apparatus embodiments may be similar to the description of above-mentioned method embodiments and have similar beneficial effects as above-mentioned method embodiments. In some embodiments, the functions or modules provided by apparatuses in embodiments of the present disclosure may be configured to execute methods described in above-mentioned method embodiment. Technical details not disclosed in apparatus embodiments of the present disclosure may refer to the description of above-mentioned method embodiments of the present disclosure for understanding.

It should be noted that in embodiments of the present disclosure, in response to that above-mentioned display control method is implemented in the form of a software function module and sold or used as an independent product, the method may also be stored in a computer-readable storage medium. Based on such understanding, the essential or contribution part of the technical solutions of embodiments of the present disclosure may be embodied in the form of software products. The computer software product may be stored in a storage medium and include multiple instructions to cause the electronic device to execute all or part of the methods described in various embodiments of the present disclosure. The above-mentioned storage media may include U disks, mobile hard disks, read only memory (ROM), magnetic disks, optical disks and/or other media that may store program codes. Therefore, embodiments of the present disclosure may not be limited to any specific combination of hardware and software.

Embodiments of the present disclosure provide a computer device, including a memory and a processor, where the memory may store a computer program that may be run on the processor, and the processor may implement some or all of exemplary steps in above-mentioned methods when executing the computer program.

Embodiments of the present disclosure provide a computer-readable storage medium, on which a computer program may be stored, and when the computer program is executed by the processor, some or all of exemplary steps in above-mentioned methods may be implemented. The computer-readable storage medium may be transitory or non-transitory.

Embodiments of the present disclosure provide a computer program, including a computer-readable code. When the computer-readable code is executed in the computer device, the processor in the computer device may execute to implement some or all of exemplary steps in above-mentioned methods.

Embodiments of the present disclosure provide a computer program product, which may include a non-transitory computer-readable storage medium storing a computer program. When the computer program is read and executed by the computer, some or all of the steps in above-mentioned methods may be implemented. The computer program product may be implemented by hardware, software or a combination thereof. In some embodiments, the computer program product may be embodied as a computer storage medium, and in other embodiments, the computer program product may be embodied as a software product, such as a software development kit (SDK) and/or the like.

It should be noted herein that the description of various above embodiments may tend to emphasize the differences between various embodiments, and same or similar aspects may be referenced to each other. The description of above-mentioned device, storage medium, computer program and computer program product embodiments may be similar to the description of above-mentioned method embodiments, which may have similar beneficial effects as method embodiments. Technical details not disclosed in the device, storage medium, computer program and computer program product embodiments of this application may refer to the description of method embodiments of the present disclosure for understanding.

It should be noted that FIG. 14 illustrates a hardware entity schematic of a computer device according to various embodiments of the present disclosure. As shown in FIG. 14, the hardware entity of the computer device 1400 may include a processor 1401, a communication interface 1402, and a memory 1403.

The processor 1401 may control overall operation of the computer device 1400.

The communication interface 1402 may enable the computer device to communicate with other terminals or servers through a network.

The memory 1403 may be configured to store instructions and applications executable by the processor 1401, and may also cache data to-be-processed or data processed by the processor 1401 and each module in the computer device 1400 (e.g.,, image data, audio data, voice communication data, and video communication data), which may be implemented by flash memory (FLASH) or random access memory (RAM). Data may be transmitted between the processor 1401, the communication interface 1402 and the memory 1403 through the bus 1404.

Various embodiments of the present disclosure provide an electronic device. The electronic device includes a memory, configured to store a computer program; and one or more processors, configured to, when the computer program is executed, perform a display control method. The method includes, in response to obtaining a first target input operation, controlling a conversation window of a first application executing current interactive task to switch from a first display state to a second display state. The conversation window only includes a main window in the first display state and includes the main window and at least one extended window in the second display state; at least one of the at least one extended window is connected to a window edge of the main window; and a functional service provided by an extended window is different from a functional service provided by the main window.

Various embodiments of the present disclosure provide a non-transitory computer-readable storage medium, containing a computer program for when executed by one or more processors, performing a display control method. The method includes, in response to obtaining a first target input operation, controlling a conversation window of a first application executing current interactive task to switch from a first display state to a second display state. The conversation window only includes a main window in the first display state and includes the main window and at least one extended window in the second display state; at least one of the at least one extended window is connected to a window edge of the main window; and a functional service provided by an extended window is different from a functional service provided by the main window.

It should be understood that “one embodiment” or “an embodiment” in the present disclosure may mean that a particular feature, a structure, or a characteristic associated with the embodiment may be included in at least one embodiment of the present disclosure. Therefore, “in one embodiment” or “in an embodiment” in various parts of the present disclosure may not be necessarily referred to same embodiment. Furthermore, features, structures or characteristics may be combined in any suitable manner in one or more embodiments. It should be understood that in various embodiments of the present disclosure, the order of the sequence numbers of above-mentioned processes may not mean the sequence of execution. The execution sequence of each process should be determined by its functions and internal logic and should not limit the implementation processes of embodiments of the present disclosure. Above sequence numbers of embodiments of the present disclosure may be only for description and may not indicate advantages or disadvantages of embodiments.

It should be noted that in the present disclosure, the terms “include”, “comprise” or any other variation thereof may be intended to cover a non-exclusive inclusion. Therefore, a process, a method, an article or an apparatus that includes a list of elements may include not only those elements, but also include other elements not expressly listed or elements which are inherent to the process, the method, the article or the apparatus. Without further limitation, an element defined by the statement “comprises a...” may not exclude the presence of additional identical elements in a process, a method, an article or an apparatus that includes such element.

In some embodiments provided in the present disclosure, it should be understood that disclosed apparatuses and methods may be implemented in other manners. The apparatus embodiments described above may be merely illustrative. Exemplarily, the division of units may be only a logical function division, and there may be other division manners in actual implementation. Exemplarily, multiple units or parts may be combined or integrated into another system, or some features may be ignored or not implemented. In addition, the coupling, direct coupling, or communication connection between the parts shown or discussed may be indirect coupling or communication connection through certain interfaces, devices or units, which may be electrical, mechanical or other forms.

The units described above as separate parts may or may not be physically separated; the parts shown as units may or may not be physical units, which may be located in one place or distributed to multiple network units; and some or all of the units may be selected according to actual needs to achieve the purpose of the solutions of embodiments.

In addition, each functional unit in each embodiment of the present disclosure may be all integrated into one processing unit; or each unit may be separately used as one unit; or two or more units may be integrated into one unit. Above integrated unit may be implemented in the form of hardware or in the form of hardware plus software functional units.

Those skilled in the art may understand that all or part of exemplary steps of above-mentioned method embodiments may be completed by hardware related to program instructions, and above-mentioned program may be stored in a computer-readable storage medium. When the program is executed, exemplary steps of above-mentioned method embodiments may be executed. Above-mentioned storage media may include mobile storage devices, read-only memory (ROM), disks, optical disks, and/or the like, which may store program codes.

Optionally, in response to that the integrated units mentioned above in the present disclosure are implemented in the form of software function modules and sold or used as independent products, the integrated units may also be stored in a computer-readable storage medium. Based on such understanding, the essential part or the contribution part of the technical solutions of embodiments of the present disclosure may be embodied in the form of software products. The computer software product may be stored in a storage medium and include various instructions to cause a computer device (which may be a personal PC, a server, a network device or the like) to perform all or part of the methods described in various embodiments of the present disclosure. Above-mentioned storage media may include mobile storage devices, ROMs, magnetic disks, optical disks, and/or other media that may store program codes.

The above may merely be embodiments of the present disclosure, but the protection scope of the present disclosure may not be limited thereto. Those skilled in the art may easily think of changes or substitutions within the technical scope disclosed in the present disclosure, which should be covered by the protection scope of the present disclosure. Therefore, the protection scope of the present disclosure should be subject to the protection scope of the claims.

The above may merely be embodiments of the present disclosure, but the protection scope of the present disclosure may not be limited thereto. Those skilled in the art may easily think of changes or substitutions within the technical scope disclosed in the present disclosure, which should be covered by the protection scope of the present disclosure. Therefore, the protection scope of the present disclosure should be subject to the protection scope of the claims.

What is claimed is

1. A display control method, comprising:
in response to obtaining a first target input operation, controlling a conversation window of a first application executing current interactive task to switch from a first display state to a second display state, wherein the conversation window only includes a main window in the first display state and includes the main window and at least one extended window in the second display state; at least one of the at least one extended window is connected to a window edge of the main window; and a functional service provided by an extended window is different from a functional service provided by the main window.

2. The method according to claim 1, wherein controlling the conversation window of the first application executing current interactive task to switch from the first display state to the second display state includes at least one of following:
controlling the conversation window to switch from only displaying the main window to simultaneously displaying the main window and the at least one extended window; and controlling at least one option identifier in the main window to switch from a first state to a second state;
controlling the conversation window to switch from only displaying the main window to simultaneously displaying the main window and the at least one extended window; and displaying and outputting first target content in the at least one extended window, wherein the first target content is obtained from the main window or generated from a first target input operation; or
controlling the conversation window to switch from only displaying the main window to simultaneously displaying the main window and the at least one extended window; and at least controlling the main window to switch from a first display parameter to a second display parameter.

3. The method according to claim 2, wherein displaying and outputting the first target content in the at least one extended window includes at least one of following:
determining attribute information of a target object pointed by the first target input operation; and controlling the at least one extended window to display and output the target object from the main window or display and output associated content generated after the target object is triggered based on the attribute information;
determining an operation region of the first target input operation; and controlling the at least one extended window to display and output the target object from the operation region or display and output associated content matching the first target input operation based on the operation region; or
determining a behavior parameter of the first target input operation; and controlling the at least one extended window to display and output current display content or folded display content from the main window or display and output the associated content matching the first target input operation based on the behavior parameter.

4. The method according to claim 1, wherein controlling the conversation window of the first application to switch from the first display state to the second display state includes at least one of following:
controlling the conversation window to switch from only displaying the main window to simultaneously displaying the main window and a first extended window, wherein a right edge of the first extended window is connected to a left edge of the main window;
controlling the conversation window to switch from only displaying the main window to simultaneously displaying the main window and a second extended window, wherein a lower edge of the second extended window is connected to an upper edge of the main window;
controlling the conversation window to switch from only displaying the main window to simultaneously displaying the main window and a third extended window, wherein an upper edge of the third extended window is connected to a lower edge of the main window;
controlling the conversation window to switch from only displaying the main window to simultaneously displaying the main window and a fourth extended window, wherein a left edge of the fourth extended window is connected to a right edge of the main window;
controlling the conversation window to switch from only displaying the main window to simultaneously displaying the main window and a plurality of fifth extended windows, wherein the plurality of fifth extended windows is stacked with each other on a left side of the main window and all connected to the left edge of the main window, or the plurality of fifth extended windows is tiled on the left side of the main window; or
controlling the conversation window to switch from only displaying the main window to simultaneously displaying the main window, at least one sixth extended window and at least one seventh extended window, wherein the at least one sixth extended window is arranged on the left side of the main window and connected to the left edge of the main window, and the at least one seventh extended window is arranged on a right side of the main window and connected to the right edge of the main window.

5. The method according to claim 1, wherein controlling the conversation window of the first application to switch from the first display state to the second display state includes at least one of following:
obtaining a quantity and/or types of operation objects acted by the first target input operation; and based on the quantity and/or types of operation objects, controlling the conversation window to switch from only displaying the main window to simultaneously displaying the main window and a target quantity of extended windows, wherein a quantity of extended windows is same as or different from the quantity of operation objects; or
obtaining a task process triggered by the first target input operation; and controlling the conversation window to switch from only displaying the main window to simultaneously displaying the main window and an extended window matching the task process, wherein display layout information of extended windows corresponding to different task processes is different.

6. The method according to claim 5, further including:
obtaining target reference information, and controlling a relative position between the at least one extended window and the main window based on the target reference information, wherein the target reference information includes at least one of following: usage habit of a target user; screen configuration information of an electronic device; application information of a second application currently running on the electronic device; task process information carried by the at least one extended window; or a quantity of extended windows.

7. The method according to claim 1, further including:
in response to obtaining a second target input operation acting on the main window and/or the at least one extended window, transferring second target content between the main window and the at least one extended window, thereby updating corresponding content in the at least one extended window using the second target content or associated content of the second target content, wherein the second target content is generated based on the second target input operation.

8. The method according to claim 7, wherein transferring the second target content between the main window and the at least one extended window to update corresponding content in the at least one extended window using the second target content or the associated content of the second target content includes at least one of following:
transferring the second target content, generated by the second target input operation acting on the main window, to the at least one extended window, thereby replacing the first content in the at least one extended window with the second target content and completing update of the at least one extended window, wherein the second target input operation is an operation for optimizing the first content;
transferring the second target content, generated by the second target input operation acting on the at least one extended window, to the main window; generating associated content corresponding to the second target content in the main window; and transferring the associated content back to the at least one extended window, thereby replacing the second target content in the at least one extended window with the associated content and completing the update of the at least one extended window; or
transferring the second target content, generated by the second target input operation acting on a first extended window, to the main window; generating associated content corresponding to the second target content in a second extended window called up by the main window; and transferring the associated content back to the first extended window, thereby replacing the second target content in the first extended window with the associated content and completing update of the first extended window.

9. The method according to claim 1, further including:
in response to a target event, controlling the conversation window of the first application to switch from simultaneously displaying the main window and the at least one extended window to only displaying the main window, wherein the target event includes at least one of following:
a target track operation acting on the at least one extended window;
a first operation acting on a target region of a first edge of the at least one extended window, wherein the first edge is a window edge away from an edge where the main window is connected to the at least one extended window;
a second operation acting on a foldable control of the at least one extended window, wherein the foldable control is capable of being trigged by the second operation, such that the at least one extended window is stored at a corresponding edge of the main window, and/or the foldable control is capable of changing corresponding control logic after the at least one extended window is stored at the corresponding edge of the main window;
detecting an execution result of a target task displayed and outputted by the at least one extended window; or
obtaining feedback information on target prompt information of the target task displayed and outputted by the at least one extended window, wherein the feedback information is configured to accept or not accept the execution result of the target task.

10. An electronic device, comprising:
a memory, configured to store a computer program; and
one or more processors, configured to, when the computer program is executed, perform:
in response to obtaining a first target input operation, controlling a conversation window of a first application executing current interactive task to switch from a first display state to a second display state, wherein the conversation window only includes a main window in the first display state and includes the main window and at least one extended window in the second display state; at least one of the at least one extended window is connected to a window edge of the main window; and a functional service provided by an extended window is different from a functional service provided by the main window.

11. The electronic device according to claim 10, wherein the one or more processors are further configured to perform at least one of following:
controlling the conversation window to switch from only displaying the main window to simultaneously displaying the main window and the at least one extended window; and controlling at least one option identifier in the main window to switch from a first state to a second state;
controlling the conversation window to switch from only displaying the main window to simultaneously displaying the main window and the at least one extended window; and
displaying and outputting first target content in the at least one extended window, wherein the first target content is obtained from the main window or generated from a first target input operation; or
controlling the conversation window to switch from only displaying the main window to simultaneously displaying the main window and the at least one extended window; and at least controlling the main window to switch from a first display parameter to a second display parameter.

12. The electronic device according to claim 11, wherein the one or more processors are further configured to perform at least one of following:
determining attribute information of a target object pointed by the first target input operation; and controlling the at least one extended window to display and output the target object from the main window or display and output associated content generated after the target object is triggered based on the attribute information;
determining an operation region of the first target input operation; and controlling the at least one extended window to display and output the target object from the operation region or display and output associated content matching the first target input operation based on the operation region; or
determining a behavior parameter of the first target input operation; and controlling the at least one extended window to display and output current display content or folded display content from the main window or display and output the associated content matching the first target input operation based on the behavior parameter.

13. The electronic device according to claim 10, wherein the one or more processors are further configured to perform at least one of following:
controlling the conversation window to switch from only displaying the main window to simultaneously displaying the main window and a first extended window, wherein a right edge of the first extended window is connected to a left edge of the main window;
controlling the conversation window to switch from only displaying the main window to simultaneously displaying the main window and a second extended window, wherein a lower edge of the second extended window is connected to an upper edge of the main window;
controlling the conversation window to switch from only displaying the main window to simultaneously displaying the main window and a third extended window, wherein an upper edge of the third extended window is connected to a lower edge of the main window;
controlling the conversation window to switch from only displaying the main window to simultaneously displaying the main window and a fourth extended window, wherein a left edge of the fourth extended window is connected to a right edge of the main window;
controlling the conversation window to switch from only displaying the main window to simultaneously displaying the main window and a plurality of fifth extended windows, wherein the plurality of fifth extended windows is stacked with each other on a left side of the main window and all connected to the left edge of the main window, or the plurality of fifth extended windows is tiled on the left side of the main window; or
controlling the conversation window to switch from only displaying the main window to simultaneously displaying the main window, at least one sixth extended window and at least one seventh extended window, wherein the at least one sixth extended window is arranged on the left side of the main window and connected to the left edge of the main window, and the at least one seventh extended window is arranged on a right side of the main window and connected to the right edge of the main window.

14. The electronic device according to claim 10, wherein the one or more processors are further configured to perform at least one of following:
obtaining a quantity and/or types of operation objects acted by the first target input operation; and based on the quantity and/or types of operation objects, controlling the conversation window to switch from only displaying the main window to simultaneously displaying the main window and a target quantity of extended windows, wherein a quantity of extended windows is same as or different from the quantity of operation objects; or
obtaining a task process triggered by the first target input operation; and controlling the conversation window to switch from only displaying the main window to simultaneously displaying the main window and an extended window matching the task process, wherein display layout information of extended windows corresponding to different task processes is different.

15. The electronic device according to claim 14, wherein the one or more processors are further configured to:
obtain target reference information, and control a relative position between the at least one extended window and the main window based on the target reference information, wherein the target reference information includes at least one of following: usage habit of a target user;
screen configuration information of an electronic device; application information of a second application currently running on the electronic device; task process information carried by the at least one extended window; or a quantity of extended windows.

16. The electronic device according to claim 10, wherein the one or more processors are further configured to:
in response to obtaining a second target input operation acting on the main window and/or the at least one extended window, transfer second target content between the main window and the at least one extended window, thereby updating corresponding content in the at least one extended window using the second target content or associated content of the second target content, wherein the second target content is generated based on the second target input operation.

17. The electronic device according to claim 16, wherein the one or more processors are further configured to perform at least one of following:
transferring the second target content, generated by the second target input operation acting on the main window, to the at least one extended window, thereby replacing the first content in the at least one extended window with the second target content and completing update of the at least one extended window, wherein the second target input operation is an operation for optimizing the first content;
transferring the second target content, generated by the second target input operation acting on the at least one extended window, to the main window; generating associated content corresponding to the second target content in the main window; and transferring the associated content back to the at least one extended window, thereby replacing the second target content in the at least one extended window with the associated content and completing the update of the at least one extended window; or
transferring the second target content, generated by the second target input operation acting on a first extended window, to the main window; generating associated content corresponding to the second target content in a second extended window called up by the main window; and transferring the associated content back to the first extended window, thereby replacing the second target content in the first extended window with the associated content and completing update of the first extended window.

18. The electronic device according to claim 10, wherein the one or more processors are further configured to:
in response to a target event, control the conversation window of the first application to switch from simultaneously displaying the main window and the at least one extended window to only displaying the main window, wherein the target event includes at least one of following:
a target track operation acting on the at least one extended window;
a first operation acting on a target region of a first edge of the at least one extended window, wherein the first edge is a window edge away from an edge where the main window is connected to the at least one extended window;
a second operation acting on a foldable control of the at least one extended window, wherein the foldable control is capable of being trigged by the second operation, such that the at least one extended window is stored at a corresponding edge of the main window, and/or the foldable control is capable of changing corresponding control logic after the at least one extended window is stored at the corresponding edge of the main window;
detecting an execution result of a target task displayed and outputted by the at least one extended window; or
obtaining feedback information on target prompt information of the target task displayed and outputted by the at least one extended window, wherein the feedback information is configured to accept or not accept the execution result of the target task.

19. A non-transitory computer-readable storage medium containing a computer program that when being executed, causes one or more processors to perform:
in response to obtaining a first target input operation, controlling a conversation window of a first application executing current interactive task to switch from a first display state to a second display state, wherein the conversation window only includes a main window in the first display state and includes the main window and at least one extended window in the second display state; at least one of the at least one extended window is connected to a window edge of the main window; and a functional service provided by an extended window is different from a functional service provided by the main window.

20. The storage medium according to claim 19, wherein the one or more processors are further configured to perform at least one of following:
controlling the conversation window to switch from only displaying the main window to simultaneously displaying the main window and the at least one extended window; and controlling at least one option identifier in the main window to switch from a first state to a second state;
controlling the conversation window to switch from only displaying the main window to simultaneously displaying the main window and the at least one extended window; and displaying and outputting first target content in the at least one extended window, wherein the first target content is obtained from the main window or generated from a first target input operation; or
controlling the conversation window to switch from only displaying the main window to simultaneously displaying the main window and the at least one extended window; and at least controlling the main window to switch from a first display parameter to a second display parameter.
